(19) United States
(12) Patent Application Publication
(10) Pub. No.: US 2009/0119984 A1
(43) Pub. Date: May 14, 2009

(54) Apparatus and Method For Planting and/or Training Trees

(76) Inventor: Ibrahim Nabhan, Greenacres, FL (US)

Correspondence Address: JOHN C. SMITH, ESQ., 2499 GLADES ROAD, SUITE 113, BOCA RATON, FL, 33431, US

(21) Appl. No.: 12/029,436

(22) Filed: Feb. 11, 2008

Related U.S. Application Data
(63) Continuation-in-part of application No. 11/983,820, filed on Nov. 14, 2007, now abandoned.

(51) Int. Cl. A01G 17/04

(52) U.S. Cl. 47/43

(57) ABSTRACT

An adjustable trunk support system which restrains a tree trunk within a specified containment area without permanently attaching to the trunk. One or more trunk supports are vertically adjustable to allow multiple trunk supports to be embedded in the ground at different heights on a slope while restraining the tree at the same height on the trunk. Adjustable arms laterally extend from the trunk supports such that the size of the containment area can be adjusted to accommodate tree growth. Adjustable locking ties secure to the adjustable arms to provide increased stability, and to provide pressure for the purpose of restraining, and/or training, a tree trunk.

### CROSS-REFERENCE TO RELATED APPLICATIONS

This non-provisional patent application is a continuation-in-part application which is related to, and claims the benefit of, currently pending non-provisional patent application Ser. No. 11/983,820, filed Nov. 14, 2007, titled “Tree Adjuster,” and naming Ibrahim Nabhan, the named inventor herein, as sole inventor, and is hereby incorporated herein in its entirety.

### BACKGROUND

### TECHNICAL FIELD

This invention relates in general to a tree positioning/training system, and more particularly it relates to a device which can be used to properly plant new trees, and/or to train or correct the position of existing trees.

### BACKGROUND OF THE INVENTION

A significant cost involved with any landscaping project is the planting and maintenance of trees. There are many difficulties faced by both professional landscapers, as well as individual gardeners, in regards to planting of trees. These difficulties include proper placement of new trees, proper irrigation and fertilization, etc. Difficulties related to proper placement of trees fall into several categories: First, when planting a new tree it is important to stabilize the tree in an upright position long enough for roots to grow. Stabilization of the tree is required because the roots have not had an opportunity to grow sufficiently such that the tree is securely anchored to the ground. If not properly stabilized during this period, trees can fall over completely, or tilt such that they provide an undesirable appearance and continue to grow in an undesirable manner. It is important to secure the tree in a fixed position until its roots have matured and grown to the point where they secure the tree in position. Once the roots have matured, the tree becomes self-reliant, and nature is allowed to take its course. Prior art attempts to stabilize trees typically rely on angled posts which press against the tree trunk via braces which are nailed to the trees. Unfortunately, this will typically result in permanent damage to the tree trunk, as well as providing an undesirable appearance. It would be desirable to have a method of stabilizing trees which does not do any damage to the trunk of the tree and provides a more aesthetically pleasing appearance.

A second issue is related to problems associated with trees that have grown in an undesirable manner and/or slant at an undesirable angle. In many cases, there is little that can be done to correct undesirable slanting of the tree trunk due to the size of the trees. While a devices have been developed to plant trees, the prior art has not developed any effective method of correcting or training full-size trees. It would be desirable to train full-size trees, even trees which have been planted for a substantial period of time, such that they produce a desired appearance.

A third problem with prior art methods of planting trees is related to planting trees on sloped surfaces. The prior art method of supporting newly planted trees using the angled post and brace method, discussed above, can be difficult and cumbersome to use depending on the slope of the ground in which the tree is planted. For example, the ground slope may require that the brace is positioned lower on the tree that it should be, or may require that longer posts are used. It would be desirable to have a method of properly stabilizing a tree trunk at any predetermined height regardless of the slope of the ground surface where the tree is planted. Methods used today to combat these issues are outdated and ineffective, and in most cases risk harming the tree.

Yet another problem associated with prior art methods of stabilizing newly planted trees is that the bracing means used does not adjust to tree growth. As a result, the portion of the trunk which the braces are secured to will, over time, constrain growth in that portion of the trunk such that when the braces are ultimately removed, the trunk will be unsightly and may have permanent damage. It would be desirable to have a device which can stabilize the trunk, and further have the ability to adjust to changes in trunk diameter caused by normal tree growth.

A further difficulty associated with prior art systems is the amount of labor required to install prior art bracing for tree. In particular, it typically takes up to three people to install prior art bracing tree bracing. One person is used to hold wood blocks against the tree trunk, a second person typically places retaining straps around the blocks and secures the boards to the blocks, while a third person holds the tree in position during the process. It would be desirable to have a method for planting and/or training trees which could be done by a single person.

In addition to the problems discussed above, there are climates where weather can have a severe impact on trees. For example, in southern U.S. coastal locations, hurricanes can be a significant problem in terms of the wind damage they inflict on trees. Likewise, northern U.S. locations also have severe weather, such as winter storms which place substantial amounts of snow on trees, which can damage trees due to the weight exerted on the branches and trunks by the snow. It would be desirable to have a method of restraining tree trunks from excessive flexing during a storm and thereby minimize the damage to the trunk during the storm.

While the prior art has attempted to provide a means to stabilize trees, it has failed to provide a personal system which can be used to stabilize newly planted trees without damaging the trunk, which can be used to train newly planted trees or trees which have been growing in the same place for an extended period, which can be used to stabilize trees which are planted on ground which has an irregular slope, which can be adjustable to accommodate growth in the tree trunk diameter, which can be used to stabilize tree trunks during storms.

### SUMMARY OF THE INVENTION

The invention provides an adjustable trunk support system, having one or more trunk adjusters, which confine a tree trunk within a specified containment area without permanently attaching to the trunk. Each trunk adjuster has a vertical leg support, a height adjustable leg segment, and a horizontally adjustable arm. A vertical leg support and the height adjustable leg segment are vertically adjustable in relation to one another to allow multiple trunk adjusters to be embedded in the ground at different heights on a slope while at the same time restraining the tree at the same height on the trunk. The trunk adjusters further comprise adjustable arms that are horizontally extendable such that the containment area surrounding the trunk can be adjusted to accommodate both initial tree size and future tree growth. Adjustable locking ties are provided to stabilize the trunk adjuster, to provide pressure for the purpose of restraining newly planted tree, and/or to train an existing tree whose trunk has grown in an improper direction.

### BRIEF DESCRIPTION OF THE DRAWINGS

FIG. 1A is a side view of a prior art method of stabilizing newly planted trees.

FIG. 1B is a partial side view of a prior art method of stabilizing newly planted trees.

FIG. 2A is a side view of a preferred embodiment of the tree planting/training system using multiple tree adjusters.

FIG. 2B is a side view of a preferred embodiment of the tree planting/training system using multiple tree adjusters and locking ties.

FIG. 3 is an exploded side view of a preferred embodiment of a tree adjuster.

FIG. 4A is a transparent perspective view of a preferred embodiment of the height adjustable leg segment with attached locking pin.

FIG. 4B is a cutaway side view of a preferred embodiment of the height adjustable leg segment illustrating the attached locking pin secured by a conventional cotter pin.

FIG. 4C is a cutaway side view of an alternative preferred embodiment of the height adjustable leg segment illustrating a spring-loaded locking pin secured by a ball bearing lock.

FIG. 5 is a side view of a preferred embodiment of the height adjustable leg segment having multiple securing apertures, and an attached locking pin.

FIG. 6A is a perspective view of a preferred embodiment of the horizontally adjustable arm having multiple securing apertures.

FIG. 6B is a top partial view of a preferred embodiment of the horizontally adjustable arm controlling the movement of a tree trunk.

FIG. 6C is a top partial view of a preferred embodiment of the horizontally adjustable arm training a tree trunk, and secured by locking ties.

FIG. 6D is a top partial view of a preferred embodiment of two horizontally adjustable arms restraining movement of a tree trunk, with each horizontally adjustable arm secured by locking ties.

FIG. 6E is a top partial view of a preferred embodiment of a plurality of horizontally adjustable arms restraining movement of multiple tree trunks, with each horizontally adjustable arm secured by locking ties.

FIG. 7A illustrates a side view of a preferred embodiment of the tree adjuster that shows the tree adjuster training an improperly slanted tree.

FIG. 7B illustrates a top view of a preferred embodiment of the tree adjuster that shows a tree trunk trained to a new position over time.

### DETAILED DESCRIPTION OF THE PREFERRED EMBODIMENT

Prior to a discussion of the figures, an overview of the invention will be presented. The invention is a tree adjuster which can be used either for properly planting new trees, or for training existing trees which have grown with an improper slant. The device provides a substantially vertical component which is comprised of a vertical leg support and a height adjustable leg segment. Extending from the height adjustable leg segment is a horizontally adjustable arm which extends in a substantially horizontal direction.

In the preferred embodiment, the vertical leg support is a substantially square or rectangular cross sectional hollow leg which is placed inground. The vertical leg support has an internal channel sized to accept the height adjustable leg segment. The height adjustable leg segment is a cylindrical structure and is inserted into the vertical leg support. The height adjustable leg segment may be adjusted to achieve the desired height using the provided locking pin. In addition, the height adjustable leg segment may also be rotated to achieve the proper alignment with a tree.

The vertical leg support is embedded in the ground to provide a secure base for the tree adjuster which will prevent its movement. The height adjustable leg segment is designed to work in coordination with the vertical leg support to allow the height of each tree adjuster to be adjusted so that the tree adjuster will contact the tree at selectable heights on the tree trunk, and also to be adjustable for tree growth. Likewise, a horizontally adjustable arm is provided which allows the distance between the height adjustable leg segment and the tree to vary. Those skilled in the art will recognize that the angle which the horizontally adjustable arm extends from the height adjustable leg segment to tree can vary and is not critical.

During installation, two locking ties are attached to apertures in the horizontally adjustable arms. The locking ties are then stretched and secured to the ground via stakes. This is done by driving the attached stakes into the ground. These steps are repeated on the other side of the tree for additional support. When planting most trees, only two tree adjusters are required. For larger trees, a third tree adjuster may be used. The tree adjusters are now in position, and resist any rotation of the tree due to high winds or exterior forces. The tree adjuster may also be used to correct slanted trees that were planted using improper or outdated methods. A single tree adjuster, applied to the slanted side of a tree, will apply enough pressure to slowly mend a tree back to an upright position. The user will continue to adjust the horizontally adjustable arms and locking ties over time until the desired position is achieved.

It should be noted that a significant advantage provided by the invention is that it provides the ability for a single person to install the tree adjuster. In contrast of the prior art which, can require up to three people to install a tree brace, the tree adjuster can be installed and adjusted by a single individual. As a result, labor costs are sharply reduced.

An important feature of the invention is that while it comes in contact with the tree, it does not restrict growth of the tree trunk as is done by prior art methods which actually damage the trunk of the tree. Further, the device does not securely attach to the tree at all. In particular, it merely provides constant pressure to urge the tree in a particular direction. As a result, it can be used not only for planting new trees, but also can be used to rehabilitate and reshape (i.e. train) pre-existing trees.

Another important advantage of the invention is that it provides a reusable tree adjuster which can be moved from one location to another, and from one application to another. This improves on the prior art in that prior art methods of the restraining trees typically involve the use of wooden blocks which are nailed or strapped to trees, and which are discarded after a single use. As a result, the tree adjuster is both environmentally friendly and more economical over the long-run. In addition, since it is designed to be a reusable device, it can be fabricated such that it has an aesthetically appealing appearance. This provides a substantial improvement over prior art devices which may look as though they were thrown together with little concern or care for aesthetics.

In the preferred embodiment, the height adjustable leg segment can be rotated to allow freedom of positioning of the horizontally adjustable arm. In addition, the horizontally adjustable arm is also rotatable to allow it to be adjusted to fit against a tree trunk in the most convenient manner.

Those skilled in the art will recognize that the tree adjuster can be fabricated from any suitable material. The only requirement is that the material selected must be suitable for the outdoor environment in which it will be used, and should have suitable wear characteristics for long-term use over many applications.

In addition to training a pre-existing tree or stabilizing a newly planted tree, the tree adjuster can also be used for multiple trees as in the case where multiple trees are planted in close proximity to one another, or in the situation where a tree has multiple trunks. Likewise, the tree adjuster can also be used to correct unwanted trunk slanting caused by a variety of environmental factors. For example, places subject to intense storms, such as the hurricanes which frequently strike the southern US coast, or northern locations which are subject to heavy snow storms where the weight of the snow may cause tree trunks to be slanted.

The tree adjuster overcomes the foregoing drawbacks by replacing the method of attaching nails, wood strips, and straps or ropes directly to the tree. The tree adjuster resists against any change in the position of a tree, but is never nailed or tied directly to the tree trunk. This ensures that the tree is allowed to grow in a natural manner and that the trunk is never pierced.

Due to the stability and structure provided by the tree adjuster, it is also capable of being used in narrow plots of land such as that often found on islands between traffic lanes. Due to the triangular structure of prior art planting systems, there is often insufficient room to properly stabilize the tree. The invention overcomes this by allowing trees to be stabilized with as little as two tree adjusters, and trained with as little as a single tree adjuster.

Having discussed the invention in general, we turn now to a detailed discussion of the drawings.

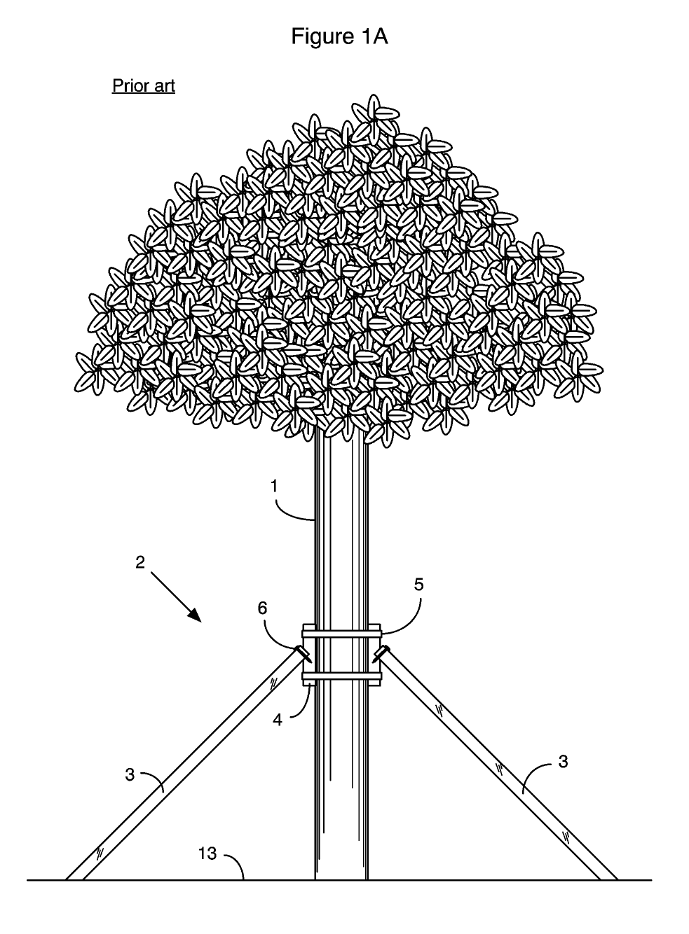

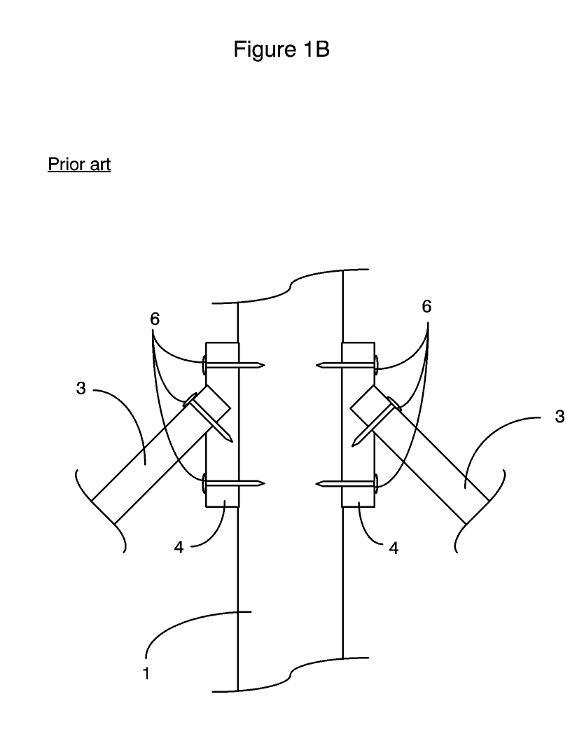

FIG. 1A is a side view of a prior art method of stabilizing a newly planted tree 1. In this figure, a new tree 1 has been planted in the ground 13, and they prior art tree support system 2 has been attached to keep the tree 1 in place. To allow time for roots to properly grow such that the tree 1 secures itself to the ground 13, trees 1 are normally supported by wooden boards 3 which are secured to wooden brackets 4 which are in turn are secured to the trunk of the tree 1. Typically, the brackets 4 are secured to the tree 1 via straps 5 or via nails 6 (illustrated below in regard to FIG. 1B). The brackets 4 provide a place to secure boards 3 which are secured to the brackets 4 at one end and buried in the ground at the other end. A problem associated with this type of tree planting procedure is that the trunk of the tree 1 is usually damaged by the brackets 4, the straps 5, the nails 6, or a combination thereof. Once the brackets 4 are removed, the tree 1 trunk may have sustained damage where the brackets 4 were attached and may have permanent aesthetic damage.

FIG. 1B is a partial side view of the prior art method of stabilizing newly planted trees which was discussed above in regard to FIG. 1A. This figure illustrates an alternative method in which, rather than strapping the brackets 4 to the tree 1, the brackets 4 are secured via nails 6 directly to the tree 1. Additional nails 6 are used to secure the board 3 to the bracket 4. If an incorrect size nail 6 is selected, then these nails will also penetrate the tree 1 trunk.

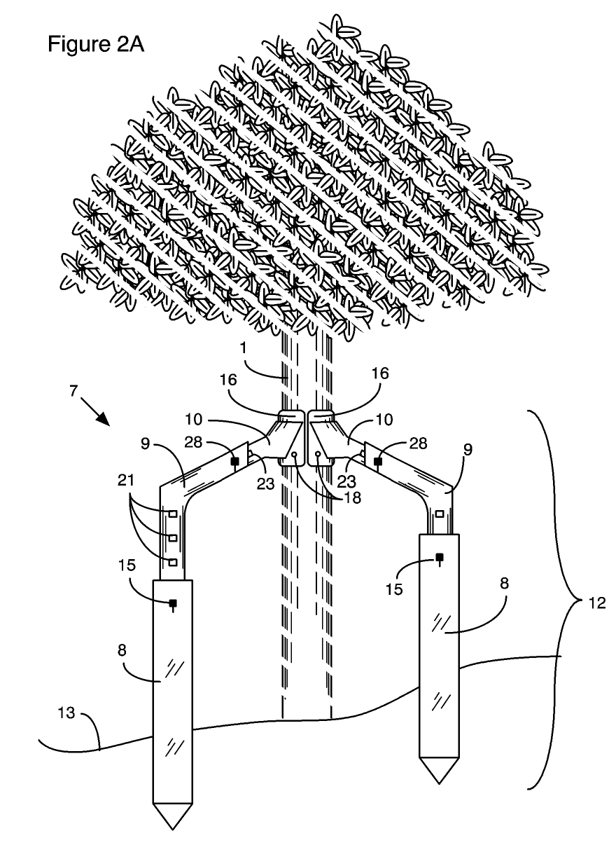

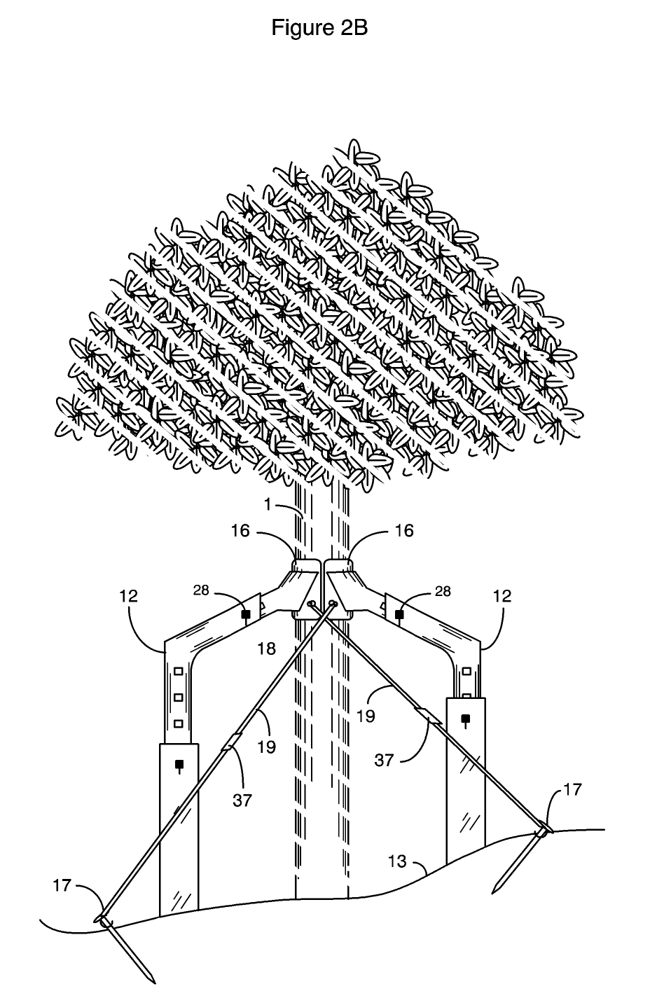

FIG. 2A is a side view of a preferred embodiment of the tree planting/training system 7 using dual tree adjusters 12. Each tree adjuster 12 includes a vertical leg support 8, a height adjustable leg segment 9, and a horizontally adjustable arm 10 which extends outward from the height adjustable leg segment 9 toward the trunk of the tree 1. For ease of discussion the horizontally adjustable arm can it is referred to using the term “horizontally,” but those skilled in the art will recognize that the angle at which the horizontally adjustable arm 10 extends toward the tree 1 can vary, so long as it provides the ability to place the vertical leg support 8 at a predetermined distance from the tree 1 such that the horizontally adjustable arm 10, when extended, will reach the trunk of the tree 1.

In the preferred embodiment, it is intended that vertical leg support 8 has sufficient length such that it can be embedded in the ground deep enough to prevent movement. Moreover preferred embodiment envisions a generally square or rectangular shape, those skilled in the art will recognize that any suitable external shape can be used so long as the vertical leg support 8 is firmly secured the ground. This is a significant improvement over prior art tree braces which tend to have their boards placed in the ground in a shallow manner. As a result, when wind places pressure on the tree it will pull the brace 3 on the windward side up from the ground. When the wind subsides, the brace will return to the ground in a different location, resulting in substandard performance and/or failure. The vertical leg support, by nature of its shape, vertical orientation, and depth of insertion in the ground will avoid this problem.

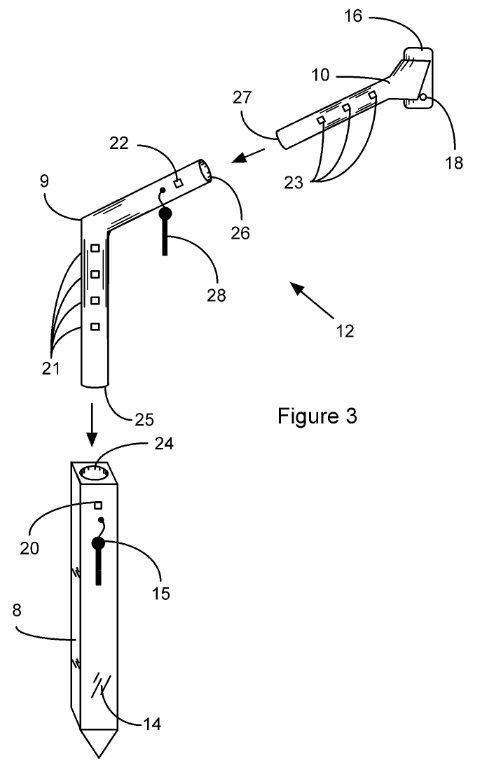

This figure also illustrates an advantage of the tree adjuster 12 in that when the ground 13 is sloped, each tree adjuster 12 can be vertically adjusted independent of one another such that they restrain the tree 1 at the same height on the trunk of the tree 1. When adjusting the height of the tree adjuster 12, locking pins 15 are inserted through apertures 20 (illustrated in FIG. 3) and 21. By selecting a particular aperture 21, the height of the tree adjuster 12 can be adjusted. For ease of illustration, only a single line of apertures 21 is shown in this figure. However, the preferred embodiment ambitions a plurality of apertures 21 at various locations on the circumference of the height adjustable leg segment 9 for the purpose of allowing a height adjustable leg segment 9 to rotate. This provides greater freedom when installing the tree adjuster 12 and aligning it with the tree 1.

Also shown are horizontally adjustable arms 10 extending outward from height adjustable leg segment 9. In similar fashion, apertures 23 are located in various locations along the length of horizontally adjustable arms 10 to allow the horizontally adjustable arms 10 to be properly aligned with, and adjusted to, the trunk of tree 1. In similar fashion, locking pin 28 is inserted through aperture 22 (illustrated below in regard to FIG. 3) and also through a selected aperture 23. This secures height adjustable leg segment 9 to horizontally adjustable arm 10.

Trunk shoe 16 is part of horizontally adjustable arm 10. It provides a large surface with which may support the trunk of a newly planted tree 1, or when a tree 1 is being trained, will supply pressure at a given angle to change the slant angle of the tree 1 over time. In the preferred embodiment the trunk shoe 16 can be fabricated from many suitable material. However, the material selected should be suitable for its intended purpose and not be something which would damage the trunk of the tree.

For ease of illustration, this figure shows the tree adjusters 12 in what appears to be a firm grasp of the tree 1 trunk. However, in practice, the tree adjuster 12 is not secured to the tree 1 such that there is any restraint on growth, or any pressure on the trunk other than that required to confine the tree within a predetermined confinement area, or required to change the slant of the tree.

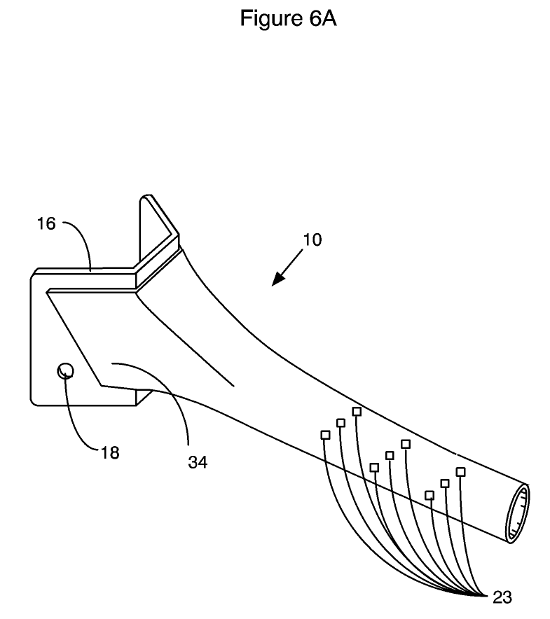

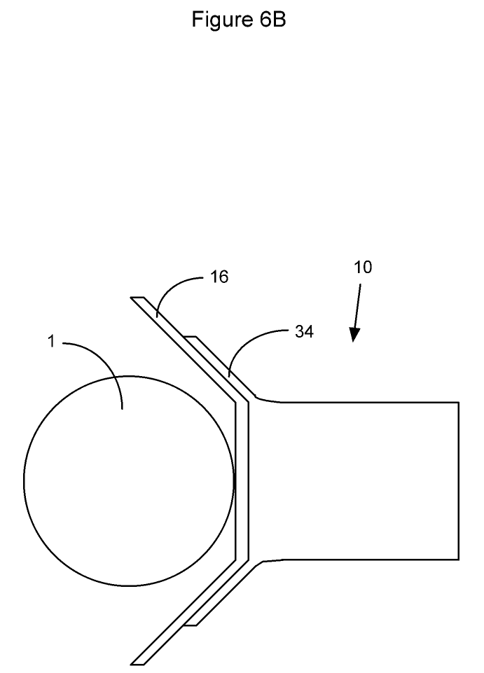

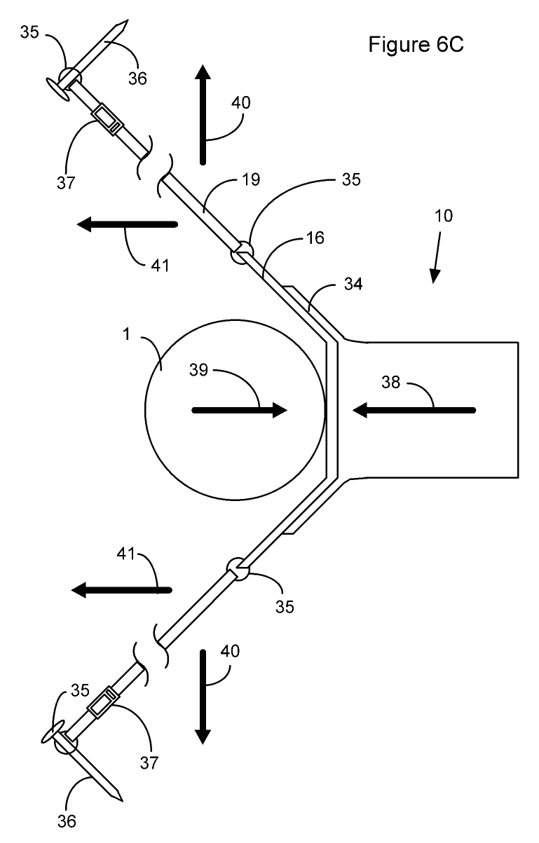

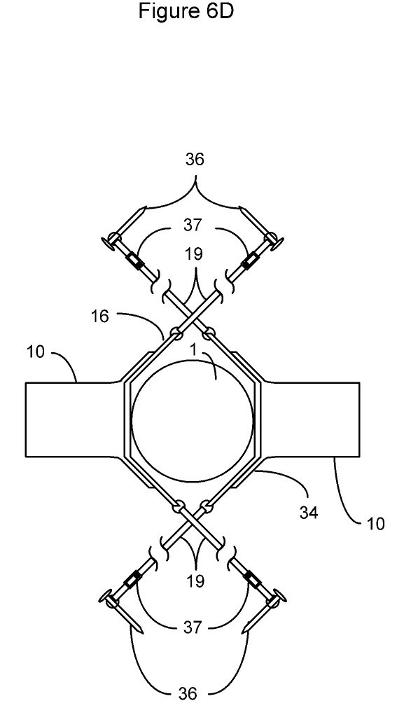

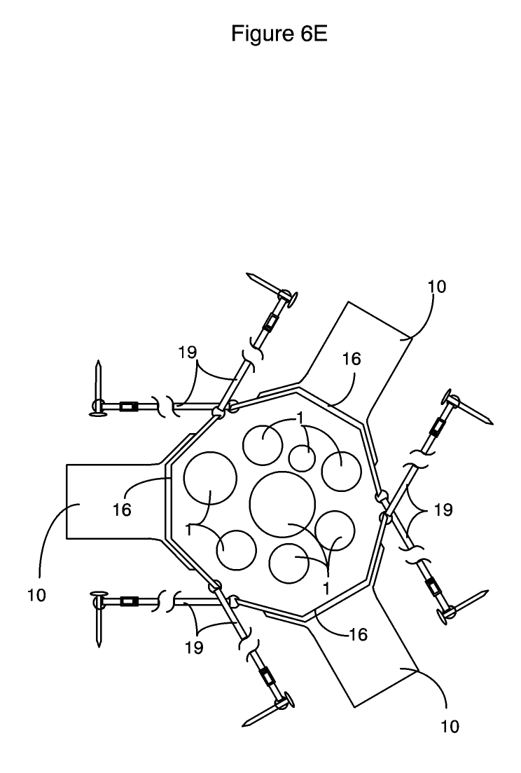

FIG. 2B is a side view of a preferred embodiment of the tree planting/training system 7 using multiple tree adjusters 12 and locking ties 19. Locking ties 19 are secured at their distal end to the ground 13 by spikes 17. They are secured at the proximal end to apertures 18 in the trunk shoe 16. Those skilled in the art will recognize that aperture 18 can also be located at the flared end 34 (illustrated below in regard to FIG. 6A) of horizontally adjustable arm 10. Locking ties 19 are positioned to provide tension on the tree adjuster 12 such that pressure is applied in the direction of the tree 1 trunk. Pressure adjusters 37 are illustrated on locking ties 19. The pressure adjusters 37 allowable length of locking ties 19 to be adjusted such that the tension provided by locking ties 19 can vary to suit conditions, and/or movement of the tree 1 trunk. In addition, locking ties 19 provide substantial extra support to prevent movement of the vertical leg support 8 which might otherwise cause by movement of the tree 1 trunk against the trunk shoe 16. Locking ties 19, and pressure adjustors 37, are commercially available as locking tie downs, and available under the trade name “Workforce” (TM), among others.

FIG. 3 is an exploded side view of a preferred embodiment of a tree adjuster 12. As shown in this figure, the preferred embodiment uses a pointed bottom 14 on the vertical leg support 8. This allows vertical leg support 8 to be more easily embedded in the ground 13. In addition vertical leg support 8 has a generally square or rectangular shape to inhibit movement when it is embedded in the ground 13. Of course, the shape can be changed to suit a variety of design choices. This figure also illustrates locking pin 15 hanging from the side of vertical leg support 8. Locking pins 15 are sized to snugly and slidably fit within aperture 20 and extend through vertical leg support 8.

Also shown in this figure is channel 24 inside of vertical leg support 8. Channel 24 is sized to allow height adjustable leg segment 9 to slidably and snugly fit within it such that height adjustable leg segment 9 can freely rotate for the purpose of aligning trunk adjuster 12 with the tree 1. As noted above, the preferred embodiment has apertures 21 located in a variety of positions to enable height adjustable leg segment 9 to be rotatably adjusted and secured in position. For ease of illustration, only a single series of apertures 21 are shown in this figure. Height adjustable leg segment 9 also has a locking pin 28 which is inserted through aperture 22 to secure horizontally adjustable arm 10 in position. When horizontally adjustable arm 10 is selectably inserted into height adjustable leg segment 9, a selected aperture 23 is aligned with aperture 26 and locking pin 28 is inserted therein to secure these two components together. Horizontally adjustable arm 10 also has a cylindrical shape to allow it to be rotated inside of height adjustable leg segment 9. As was the case above, the preferred embodiment of the horizontally adjustable arm 10 also has numerous apertures 23 located at various positions to allow horizontally adjustable arm 10 to be aligned with a tree 1.

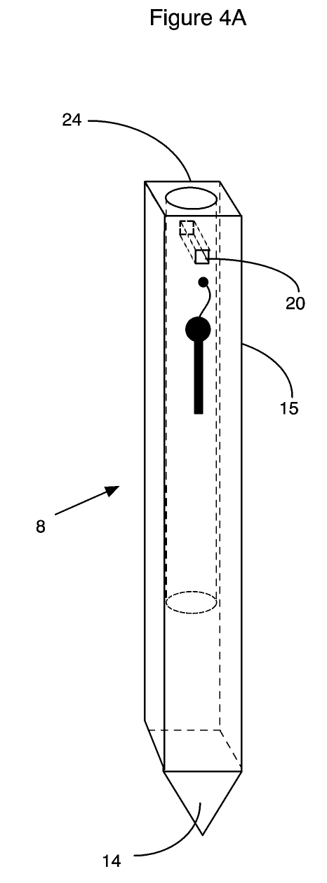

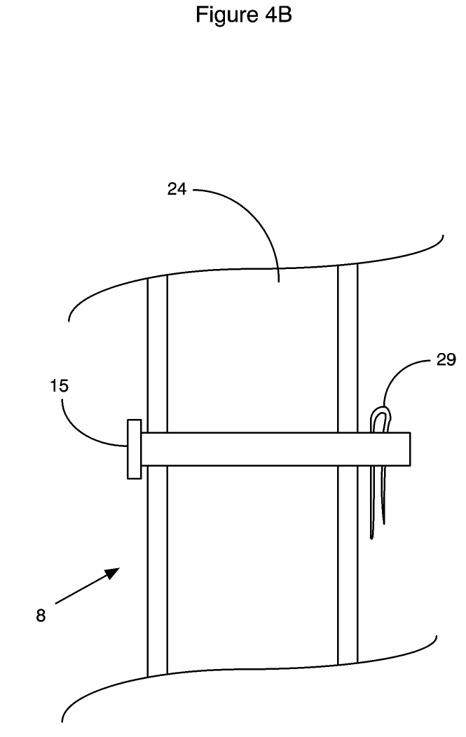

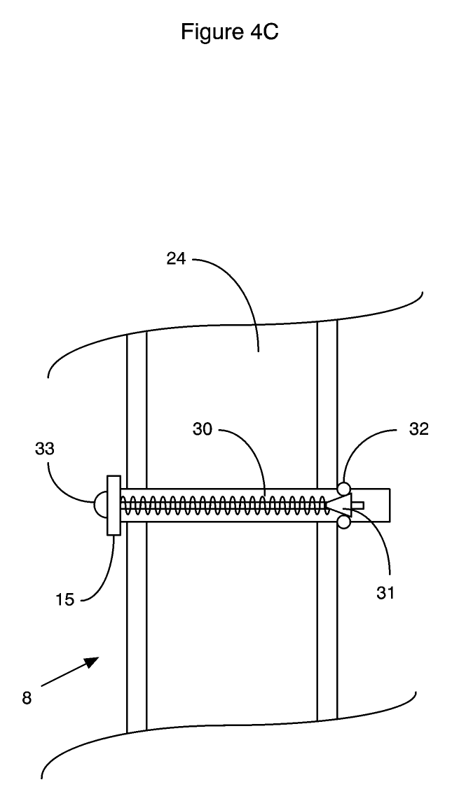

FIG. 4A is a transparent perspective view of a preferred embodiment of the height adjustable leg segment 8 with attached locking pin 15. This figure better illustrates the internal channel 24 in which height adjustable leg segment 9 rotates. This figure also illustrates in more detail aperture 20 extending through height adjustable leg segment 9.

FIG. 4B is a cutaway side view of a preferred embodiment of the height adjustable leg segment 9 illustrating the attached locking pin 15 secured by a conventional cotter pin 29. Those skilled in the art will recognize that vertical leg support 8 must be securely attached to height adjustable leg segment 9 during use. Therefore, a suitable method of securing these two components together must be used. This figure illustrates a simple method of securing locking pin 15 to vertical leg support 8 through the use of a conventional cotter pin 29. However, any suitable method of securing locking pin 15 to vertical leg support 8 can be used.

FIG. 4C is a cutaway side view of an alternative preferred embodiment of the vertical leg support 8 which illustrates a spring-loaded locking pin 15 secured by a ball bearing lock 31-32. In this figure locking pin 15 is inserted through vertical leg support 8 by pressing button 33 which pushes cam 31 away from ball bearings 32. The locking pin 15 is inserted into the aperture 20, and then the button 33 is released. Once button 33 is released this spring 30 polls came 31 power button 33 and forces the ball bearings 32 upward to secure locking pin 15 in place. Ball bearing locks such as this are well known in the art. While the foregoing examples can be used to secure locking pin 15, any suitable method can be used for this purpose.

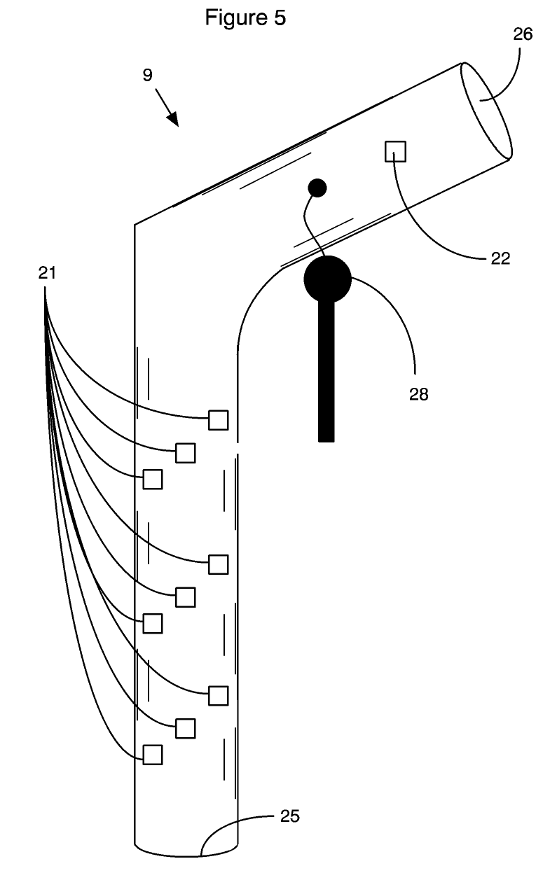

FIG. 5 is a side view of a preferred embodiment of the height adjustable leg segment 9 having multiple securing apertures 21, and an attached locking pin 28. This figure better illustrates the use of multiple apertures 21 located at various longitudinal and lateral points on the shaft of height adjustable leg segment 9. By arranging a plurality of apertures 21 at different locations, height adjustable leg segment 9 can be extended in and out of vertical leg support 8, as well as rotated freely within vertical leg support 8.

FIG. 6A is a perspective view of a preferred embodiment of the horizontally adjustable arm 10 having multiple securing apertures 23. Securing apertures 23 are used for the same purpose as the apertures 21 discussed above. They allow extension of horizontally adjustable arm 10, as well as providing the ability to rotate to different positions for the purpose of aligning trunk adjuster 12 with a tree 1. At the distal end of horizontally adjustable arm 10 is trunk shoe 16. For ease of discussion, trunk shoe 16 shown as a separate component which is secured to a reinforced base 34 at the distal end of horizontally adjustable arm 10. However, those skilled in the art will recognize that horizontally adjustable arm 10 and trunk shoe 16 can be fabricated as a single component if desired. In the preferred embodiment, trunk shoe 16 is fabricated from material which will not damage the trunk or the bark on tree 1. Also shown in this figure is aperture 18 which is used as a securing point for locking ties 19.

FIG. 6B is a top partial view of a preferred embodiment of the horizontally adjustable arm 10 controlling the movement of a tree 1 trunk. In this view, the trunk shoe 16 is shown forming a containment area to prevent movement of the tree 1 trunk against it. Of course, the size of the trunk adjuster 12, and its components such as trunk shoe 16 can vary depending on the types of trees 1 for which it is being used.

FIG. 6C is a top partial view of a preferred embodiment of the horizontally adjustable arm 10 training a tree 1 trunk, and secured by locking ties 19. In this figure, if a newly planted tree is not secure, it may tilt in one direction or another. Horizontally adjustable arm 10 provides a force 38 which counteracts force 39 from the tree 1 trunk. Locking ties 19 are secured at their proximal end to horizontally adjustable arm 10 at aperture 18 via connectors 35, and secured to the ground via spikes 36 and connectors 35. Locking ties 19 create lateral forces 40 and longitudinal forces 41. The forces 40-41 direct forces generated by the movement of the tree 1 trunk, and assist trunk adjuster 12 to remain in a stable position.

FIG. 6D is a top partial view of a preferred embodiment of two horizontally adjustable arms 10 restraining movement of a tree 1 trunk, with each horizontally adjustable arm 10 secured by locking ties 19. By using dual trunk adjuster's 12, a newly planted tree 1 can be secured within a defined containment area without requiring attachment of anything to the tree 1 trunk which may damage it.

An advantage provided by the invention is that there are areas where it is difficult to support a newly planted tree because of the limitations in the amount of available ground space. For example, in the case where a tree is planted in a narrow island in the street, two opposing tree adjustors 12 can be positioned such that they do not interfere with traffic, yet provide adequate support for a new tree 1.

FIG. 6E is a top partial view of a preferred embodiment of a plurality of horizontally adjustable arms 10 restraining movement of multiple tree 1 trunks, with each horizontally adjustable arm 10 secured by locking ties 19. For certain landscaping needs, trees 1 having multiple trunks, or multiple small trunk diameter trees 1 may be desirable. In this event, multiple tree adjusters 12 can be used for this purpose. In addition, multiple tree adjusters 12 can be used for a larger tree 1 to ensure that it is properly contained.

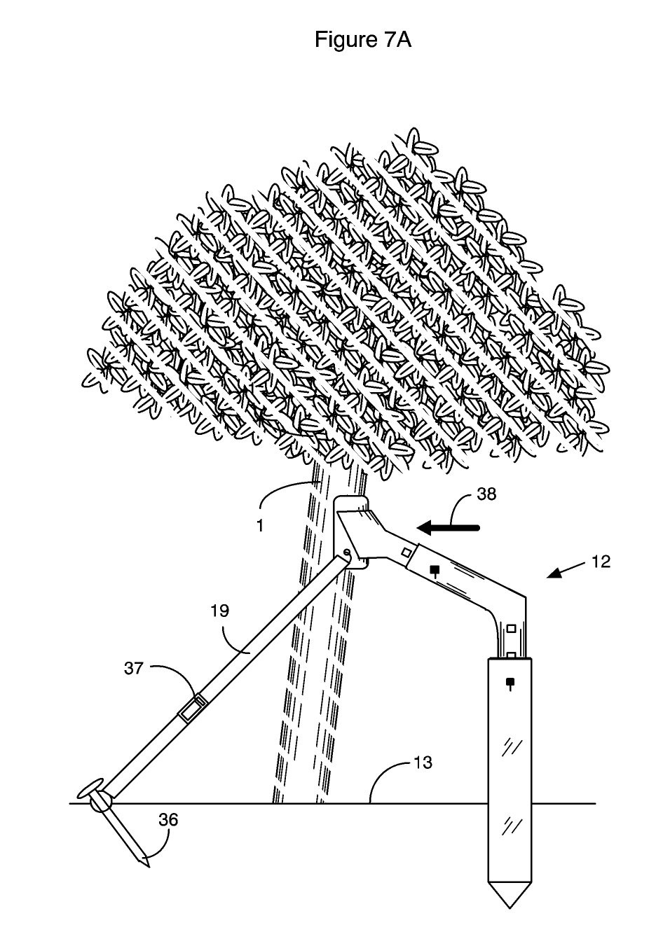

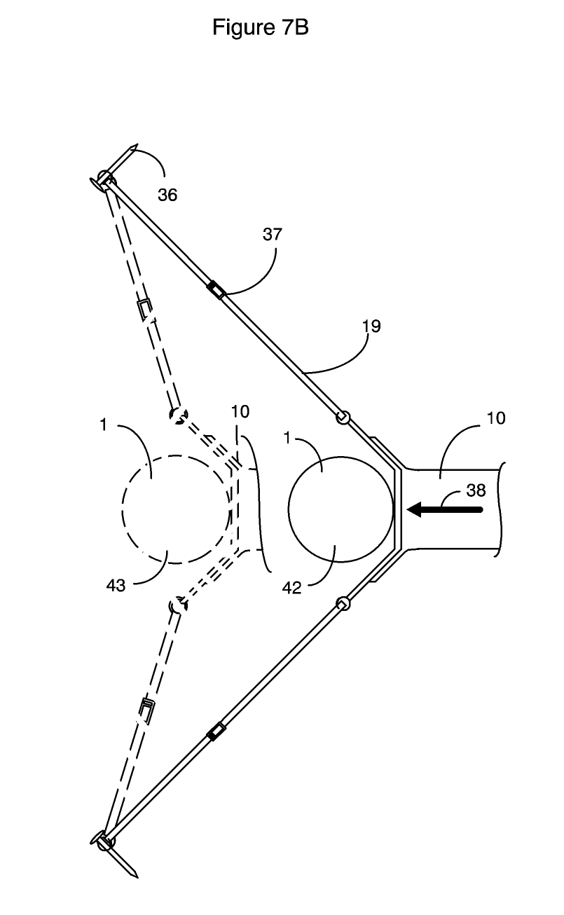

FIG. 7A illustrates a side view of a preferred embodiment of the tree adjuster 12 that shows the tree adjuster 12 training an improperly slanted tree 1. Often, it may be desirable to train a large tree 1 to adjust its slope for aesthetic reasons. An advantage provided by horizontally adjustable arm 10 is that it allows the arm to be adjusted gradually as the tree 1 trunk is moved to a more desirable shape. By extending horizontally adjustable arm 10 outward over time, the force 38 applied to the tree 1 trunk can be maintained and adjusted until the tree 1 is returned to a vertical orientation. Of course, the locking ties are also adjusted in concert with the horizontally adjustable arm 10.

FIG. 7B illustrates a top view of a preferred embodiment of the tree adjuster 12 that shows a tree 1 trunk being trained to a new position over time. Initially, tree 1 may be at location 42. Constant pressure 38 is supplied over time to tree 1 trunk by trunk shoe 16. Eventually, tree 1 is moved to desired position 43. During the course of this training period, both the locking ties 19 are adjusted via pressure adjustors 37, and the horizontally adjustable arm 10 is adjusted by extending horizontally adjustable arm 10 and securing it by selecting a new aperture to maintain pressure 38.

While specific embodiments have been discussed to illustrate the invention, it will be understood by those skilled in the art that variations in the preferred embodiments can be made without departing from the spirit and scope of the invention. For example, the locking ties can be fabricated from a number of different materials. Likewise, the materials used to fabricate the trunk adjuster can be made from any suitable material, the size of the trunk adjuster can vary, the number of trunk adjusters required for a particular task can vary, etc. Therefore, the invention shall be limited solely to the scope of the claims.

I claim:

1. A tree adjuster for stabilizing and/or training trees, comprising:
a vertical leg support having a distal end and a proximal end, the vertical leg support further having means to be secured inground;
a height adjustable leg segment having a distal end and a proximal end, the height adjustable leg segment further having means at its proximal end to be secured to the vertical leg support;
a horizontally adjustable arm having a distal end and a proximal end, the horizontally adjustable arm further having means to be secured at its proximal end to the distal end of the height adjustable leg segment; and
the horizontally adjustable arm further having a trunk shoe at its distal end suitable for adjustably controlling the position of a tree trunk.
